(19) United States
(12) Patent Application Publication
(10) Pub. No.: US 2013/0104698 A1
(43) Pub. Date: May 2, 2013

(54) Method of catalytic oxidation of U4+ to U6+ using a catalyst Muhamedzhan-1

(71) Applicants: Yerkin Aibassov, Almaty (KZ); Saltanat Aibassova, Almaty (KZ); Gizatulla Aibassov, Shinhold (GB); Zhaken Aibassov, Almaty (KZ); Mukhamejan Aibassov, Almaty (KZ); Bakhyt Abenov, Almaty (KZ)

(72) Inventors: Yerkin Aibassov, Almaty (KZ); Saltanat Aibassova, Almaty (KZ); Gizatulla Aibassov, Shinhold (GB); Zhaken Aibassov, Almaty (KZ); Mukhamejan Aibassov, Almaty (KZ); Bakhyt Abenov, Almaty (KZ)

(21) Appl. No.: 13/317,960

(22) Filed: Nov. 1, 2011

(51) Int. Cl. C22B 60/02; B01J 31/02; B01J 27/232; B01J 27/25; B01J 27/24; B01J 27/053; B01J 27/122; B01J 27/128; B01J 27/08; B01J 31/32; B01J 31/30; B01J 31/28; B01J 27/20; B01J 27/10; B01J 27/055; B01J 23/04; B01J 31/26

(52) U.S. Cl. 75/399; 502/169; 502/172; 502/174; 502/201; 502/200; 502/218; 502/225; 502/229; 502/224

(57) ABSTRACT

The proposed methods are exemplarily utilized in uranium hydrometallurgy for selective extraction of uranium out of ore by in situ or heap leaching. According to the disclosure, the methods encompass catalytic oxidation of U⁴⁺ to U⁶⁺ using a proposed oxidizing catalyst “Muhamedzhan-1”, filtration of this solution through ore, transferring hexavalent uranium, trivalent iron, and other metal ions into a production solution, extraction of uranium yielding a barren solution and re-circulation of this solution back for ore leaching. The methods essentially improve known technologies by employing “Muhamedzhan-1”, being a solution of d- and f-mixed valence metal salts (MLₙ, wherein M=Fe, U, Cu, Mn, and L=NO₃⁻, SO₄²⁻Cl⁻, Br⁻, I⁻) and alkali metal halogenides (MX, wherein M=Na⁺, Na⁺, K⁺, and X=Cl⁻, Br⁻, I⁻) used as an oxidizing agent, with the weight ratio of MLₙ: 0.01-25.0%, MX: 0.01-12.5%, and solvent: balance.

### FIELD OF THE INVENTION

The invention belongs to hydrometallurgical ore processing methods and can be utilized, in particular, in uranium hydrometallurgy for selective extraction of uranium out of ore by heap leaching and/or in situ leaching.

### BACKGROUND OF THE INVENTION

There is known a related art method of uranium heap and in situ leaching utilizing sulfuric acid. The known method involves filtration of diluted solution of sulfuric acid through strata of ore body laid down in heaps or in-situ directly through an ore bearing stratum. During this process nitric acid is added into the solution to passivate equipment. A disadvantage of the aforementioned method is its low intensity and consequently its long duration (L. I. Lunev, Mine systems of uranium deposits development by in-situ leaching, Moscow, 1982, pp. 8, 13,17). The instant inventors consider the above method as most closely related to the present invention.

U.S. Pat. No. 4,049,769 titled “Separation of uranium isotopes by accelerated isotope exchange reactions” is known. It describes uranium isotopes segregation method that includes isotope exchange reaction during which uranium (IV) and uranium (VI) ions contact in the presence of catalyst dissolved in acid environment and consisting of compounds of Cu, In, Tl, Zr, Sn, V, Nb, As, Vi, Cr, Mo, Mn, Re, Rt, Pd, Fe, Hg, and Sb. Disadvantages of this method are the complex catalyst composition, use of expensive, and rare reagents (Pd, Zr, In, Nb, Re, Rh), and inability to regenerate the used up catalyst by air oxygen. The proposed “Muhamedzhan-1” catalyst has the following distinctions and advantages: 1) catalytic oxidation of U(IV) to U(IV) proceeds with high rate and selectivity; 2) the used up catalyst easily regenerates with the air oxygen; 3) catalytic oxidation proceeds in mild conditions and low temperatures (from +4 to +60° C.); 4) the use of relatively low cost sulphuric acid; 5) simplicity and robustness of the technological process.

U.S. Pat. No. 4,312,840 titled “Process for the in-situ leaching of uranium” is known. This patent describes a process for the in-situ leaching of uranium employing an alkaline lixiviant and an alkali metal or alkaline earth metal hypochlorite as an oxidizing agent. In the above process leaching solution pH is in range of 8-10 and hypochloride is present in range of 0.1-1.0 weight percents. Disadvantages of this method are: the use of costly, toxic and environmentally dangerous chlorine, and inability of the oxidizing agent to regenerate by air oxygen. The proposed “Muhamedzhan-1” catalyst has the following distinctions and advantages: 1) new process proceeds at low pH values in range 0.5-4.0; 2) new catalyst easily regenerates with the air oxygen; 3) new process is environmentally healthier and does not use toxic and corrosive chlorine.

U.S. Pat. No. 4,402,921 titled “Ammonium carbonate and/or bicarbonate plus alkaline chlorate oxidant for recovery of uranium values” is known. This patent describes a method of low-valent uranium extraction using aqueous leaching solution that consists of alkaline chlorate, ammonium carbonate and/or ammonium bicarbonate, and compounds of the following ions: Cu²⁺, Co²⁺, Fe³⁺, Ni²⁺, Cr³⁺. The process is conducted at pH>9.0. Disadvantages of this method are: the use of costly, corrosive and toxic chlorates, and inability of the oxidizing agent to regenerate. In its turn, the proposed “Muhamedzhan-1” catalyst based process is conducted at low pH values (0.5-4.0), “Muhamedzhan-1” catalyst is environmentally friendly and can be regenerated by air oxygen.

U.S. Pat. No. 4,405,567 titled “Uranium value leaching with ammonium carbonate and/or bicarbonate plus nitrate oxidant and optionally oxidation-catalytic metal compounds” is known. This patent describes a method of low-valent uranium extraction using aqueous leaching solution that contains NH₄⁺ and NO₃⁻ ions, and metal compounds containing Cu²⁺, Co²⁺, Fe³⁺, Ni²⁺, Cr³⁺. The process is conducted at pH>9.0. A main disadvantage of this method is inability of the oxidizing agent to regenerate. The proposed “Muhamedzhan-1” catalyst can be easily regenerated by air oxygen.

In the recent time a lot of research has been conducted in the field of in situ uranium leaching utilizing different oxidizing agents. At the moment, the development of methods of catalytic oxidation of U⁴⁺ to U⁶⁺ is an issue of immediate importance.

### BRIEF SUMMARY OF THE INVENTION

The proposed methods are exemplarily utilized in uranium hydrometallurgy for selective extraction of uranium out of ore by in situ or heap leaching. The methods encompass catalytic oxidation of U⁴⁺ to U⁶⁺ using an inventive oxidizing catalyst “Muhamedzhan-1”, filtration of this solution through ore, transferring hexavalent uranium, trivalent iron, and other metal ions into a production solution, extraction of uranium yielding a barren solution and re-circulation of this solution back for ore leaching. The inventive methods essentially improve known technologies by employing a catalyst herein further called “Muhamedzhan-1”, being a solution of d- and f-mixed valence metal salts (MLₙ, where M=Fe, U, Cu, Mn, and L=NO₃⁻, SO₄²⁻Cl⁻, Br⁻, I⁻) and alkali metal halogenides (MX, where M=Li⁺, Na⁺, K⁺, and X=Cl⁻, Br⁻, I⁻) used as an oxidizing agent, with the weight ratio of: MLₙ: 0.01-25.0%, MX: 0.01-12.5%, and solvent: balance.

### DESCRIPTION OF THE INVENTION

The proposed invention contemplates the catalyst “Muhamedzhan-1” usable for catalytic oxidation of U⁴⁺ to U⁶⁺ comprising a mixture of: d- and f-mixed valence metal salts (MLₙ, wherein M is one of the following: Fe, U, Cu, and Mn, and wherein L is one of the following: NO₃⁻, SO₄²⁻Cl⁻, Br⁻, and I⁻) and alkali metal halogenides (MX, wherein M is one of the following: Li⁺, Na⁺, K⁺, and NH₄⁺, and wherein X is one of the following: Cl⁻, Br⁻, OH⁻, HCO₃⁻, CO₃²⁻, and I⁻) in the solid or dissolved state with the weight ratio of two components in the solid state m(MLₙ)/m(MX) ranging from 1:2 to 6:1 correspondingly, and water (H2O) and/or primary alcohols (ROH) and/or secondary alcohols (RRCHOH) used as a solvent, with the solution weight concentration ranging from 0.00001% to 30.0% of solid salts mixture in solution.

The proposed invention contemplates a first method of catalytic oxidation of U⁴⁺ to U⁶⁺, using a catalyst solution for uranium extraction by in situ leaching or heap leaching, wherein the first method comprises the steps of:

A1) preparation of a concentrated solution of “Muhamedzhan-1” in the form of solution of d- and f-mixed valence metal salts (MLₙ, wherein M=Fe, U, Cu, Mn, and L=NO₃⁻, SO₄²⁻Cl⁻, Br⁻, I⁻) and alkali metal halogenides (MX, wherein M=Li⁺, Na⁺, K⁺, NH₄⁺ and X=Cl⁻, Br⁻, OH⁻, HCO₃⁻, CO₃²⁻, I⁻) with the following composition in weight %:

| | |
|---|---|
| MLₙ | 0.01-25.0% |
| MX | 0.01-12.5% |
| H₂O (or primary and/or secondary alcohols ROH, RRCHOH) | balance; |

B1) preparation of a leaching solution containing sulfuric acid or ammonia hydroxide with the following composition in weight %:

| | |
|---|---|
| H₂SO₄ or NH₄OH: | 0.5-10.0% |
| H₂O (or primary and/or secondary alcohols ROH, RRCHOH): | balance, |

C1) adding the concentrated solution of “Muhamedzhan-1”, obtained on the step (A1), to the leaching solution, obtained on the step (B1), in the following volumetric % ratio:

| | |
|---|---|
| “Muhamedzhan-1”: | 0.1-10.0% |
| Leaching solution: | balance, |

thereby obtaining a leaching solution modified with “Muhamedzhan-1”;
D1) filtration of the leaching solution modified with “Muhamedzhan-1” obtained on the step (C1) through ore, with oxidation of uranium (IV) and iron (II) ions to uranium (VI) and iron (III), and a subsequent dissolution of uranium (VI), iron (III), and other metal ions in the leaching solution filtrated through ore, thereby obtaining a filtrated leaching solution containing uranium (VI) ions;
E1) extraction of uranium from the filtrated leaching solution obtained on the step (D1), and yielding a barren solution; and
F1) regeneration of “Muhamedzhan-1” in the barren solution obtained on the step (E1) by bubbling air therethrough and addition of H₂SO₄ or NH₄OH to meet their concentration requirement of the step (B1), thereby yielding the leaching solution modified with “Muhamedzhan-1” in the oxidized form, and re-circulation of the leaching solution modified with “Muhamedzhan-1” in the oxidized form back for ore leaching on the step (D1).

The proposed invention contemplates a second method of catalytic oxidation of U⁴⁺ to U⁶⁺, using “Muhamedzhan-1” for extraction of uranium by in situ leaching or heap leaching, wherein the second method comprises the steps of:

A2) preparation of a leaching solution containing sulfuric acid or ammonia hydroxide with the following components composition in weight %:

H₂SO₄ or NH₄OH: 0.5-10.0%; H2O or ROH or RRCHOH: balance;
B2) preparation of the leaching solution modified with “Muhamedzhan-1” by adding:

d- and f-mixed valence metal salts (MLₙ, wherein M is one of the following: Fe, U, Cu, and Mn, and wherein L is one of the following: NO₃⁻, SO₄²⁻Cl⁻, Br⁻, and I⁻) and

alkali metal halogenides (MX, wherein M is one of the following: Li⁺, Na⁺, K⁺, and NH₄⁺, and wherein X is one of the following: Cl⁻, Br⁻, OH⁻, HCO₃⁻, CO₃²⁻, and I⁻) in their solid state, directly to the leaching solution obtained in step (A2) with the following component fractions in weight %: MLₙ: 0.00001%-15.0%, MX: 0.00001%-10%, the leaching solution obtained in step (A2): balance;

thereby obtaining a leaching solution modified with “Muhamedzhan-1”;
C2) filtration of the leaching solution modified with “Muhamedzhan-1” obtained on the step (B2) through ore, with oxidation of uranium (IV) and iron (II) ions to uranium (VI) and iron (III), and a subsequent dissolution of uranium (VI), iron (III) and other metal ions in the leaching solution filtrated through ore, thereby obtaining a filtrated leaching solution containing uranium (VI) ions;
D2) extraction of uranium from the filtrated leaching solution obtained on the step (C2), and yielding a barren solution; and
E2) regeneration of “Muhamedzhan-1” in the barren solution obtained on the step (E2) by bubbling air therethrough and addition of H₂SO₄ or NH₄OH to meet the concentration requirement of the step (A2), thereby yielding the leaching solution modified with “Muhamedzhan-1” in the oxidized form, and re-circulation of the leaching solution modified with “Muhamedzhan-1” in the oxidized form back for ore leaching on the step (C2).

The essence of the effect produced by “Muhamedzhan-1” consists in oxidation of insoluble U⁴⁺ contained in ore into soluble U⁶⁺ and subsequent dissolution of U⁶⁺ in acid environment in case of H₂SO₄ based leaching solution, or in alkali environment in case of NH₄OH based leaching solution. Uranium (IV) salts interacting with the catalyst solution get oxidized according to the following overall reaction (1):

U⁴⁺+KT_{Ox}=U⁶⁺+KT_{Red} (1)

Used catalyst KT_{Red} regeneration process by air oxygen is described by the following reaction (2):

KT_{Red}+O₂=KT_{Ox} (2)

wherein KT_{Ox} and KT_{Red} are correspondingly oxidized and reduced forms of the catalyst's active complex.

Uranium oxidation goes according to a complex multi-stage mechanism. Temperature of catalytic oxidation process is 25-30° C., as most of the technological processes are conducted in this temperature range. In order to regenerate the used up catalyst, pressurized air is fed into a regenerator under a pressure of 2-4 atm.

The inventive catalyst was successfully tested at three uranium deposits with real uranium containing solutions.

### PREFERRED EMBODIMENTS OF THE INVENTION

While the invention may be susceptible to embodiment in different forms, there are be described in detail herein below, a specific exemplary embodiment of the present invention, with the understanding that the present disclosure is to be considered an exemplification of the principles of the invention, and is not intended to limit the invention to that as described herein.

### Example 1

In the period from 3^{rd} to 9^{th} of Dec., 2010 we have conducted laboratory tests of “Muhamedzhan-1” for oxidation of U⁴⁺ to U⁶⁺ on three samples at a physical-chemical laboratory of the “Uvanas” uranium deposit. Tests were conducted on production and leaching solutions from well #62 of Block 199 and well #125 of Block 201. Results of these tests are shown in Table 1 below.

TABLE 1
Oxidation of U⁴⁺ to U⁶⁺ by “
Muhamedzhan-1” in leaching solution
samples from 7^{th} of December 2010

| | | | |
|---|---|---|---|
| | | | Redox |
| | | | potential, |
| # | Catalyst, ml | pH | mV |

Block 201 - Well #125

| | | | |
|---|---|---|---|
| 1. | 0 | 2.16 | 441 |
| 2. | 1 | 1.53 | 452 |
| 3. | 2 | 1.44 | 458 |
| 4. | 3 | 1.34 | 464 |
| 5. | 4 | 1.29 | 472 |
| 6. | 5 | 1.28 | 476 |
| 7. | 10 | 1.07 | 492 |

Block 199 - Well #62

| | | | |
|---|---|---|---|
| 1. | 0 | 2.04 | 459 |
| 2. | 1 | 1.80 | 471 |
| 3. | 2 | 1.66 | 479 |
| 4. | 3 | 1.54 | 485 |
| 5. | 4 | 1.47 | 490 |
| 6. | 5 | 1.38 | 495 |
| 7. | 10 | 1.15 | 511 |

Leaching Solution

| 1. | 0 | 1.90 | 441 |
|---|---|---|---|
| 2. | 1 | 1.71 | 462 |
| 3. | 2 | 1.60 | 476 |
| 4. | 3 | 1.49 | 486 |
| 5. | 4 | 1.43 | 496 |
| 6. | 5 | 1.34 | 506 |
| 7. | 10 | 1.14 | 1038 |
| | | | Redox |
| | | | potential, |
| # | Catalyst + KMnO₄, ml | pH | mV |

Production Solution

| | | | |
|---|---|---|---|
| 1. | 0 | 1.88 | 435 |
| 2. | 1 | 1.98 | 996 |
| 3. | 2 | 2.00 | 1008 |
| 4. | 3 | 2.02 | 1015 |
| 5. | 4 | 2.03 | 1018 |
| 6. | 5 | 2.04 | 1025 |
| 7. | 10 | 2.05 | 1042 |

Leaching Solution

| | | | |
|---|---|---|---|
| 1. | 0 | 1.90 | 441 |
| 2. | 1 | 1.95 | 990 |
| 3. | 2 | 1.96 | 1028 |
| 4. | 3 | 1.97 | 1039 |
| 5. | 4 | 1.98 | 1046 |
| 6. | 5 | 1.99 | 1050 |
| 7. | 10 | 2.01 | 1059 |

As it is visible from test results shown in Table 1, in water solutions “Muhamedzhan-1” increases redox potential from 0.440 to 0.511V and decreases pH from 2.16 to 1.07, which allows decreasing the consumption of sulfuric acid.

### Example 2

In the period from 6^{th} to 9^{th} of Dec., 2010 laboratory tests of “Muhamedzhan-1” for oxidation of U⁴⁺ to U⁶⁺ were conducted on a leaching solution from sand pond at the physical-chemical laboratory of the “Ak Dala” uranium deposit.

Results of the catalytic oxidation of U⁴⁺ to U⁶⁺ in the leaching solution using “Muhamedzhan-1” are presented in Table 2.

TABLE 2
Oxidation of U⁴⁺ to U⁶⁺ using “Muhamedzhan-1”

| | | | Redox | | | | Redox |
|---|---|---|---|---|---|---|---|
| | Catalyst, | | potential, | | Catalyst, | | potential, |
| # | ml | pH | mV | # | ml | pH | mV |
| 1 | 0 | 2.06 | 393 | 1 | 0 | 2.06 | 387 |
| 2 | 1 | 1.96 | 402 | 2 | 1 | 1.93 | 416 |
| 3 | 2 | 1.95 | 419 | 3 | 2 | 1.91 | 420 |
| 4 | 3 | 1.93 | 424 | 4 | 3 | 1.90 | 429 |
| 5 | 4 | 1.90 | 434 | 5 | 4 | 1.80 | 439 |
| 6 | 5 | 1.89 | 440 | 6 | 5 | 1.76 | 447 |
| 7 | 6 | 1.78 | 450 | 7 | 6 | 1.68 | 452 |
| 8 | 7 | 1.60 | 488 | 8 | 7 | 1.47 | 480 |

As it is visible from test results shown in Table 2 utilization of “Muhamedzhan-1” increases redox potential from 387 to 480 mV and decreases pH from 2.06 to 1.47, which allows increasing the uranium yield of the leaching solution and decreasing the consumption of sulfuric acid.

### Example 3

We have conducted industrial pilot tests of “Muhamedzhan-1” on increasing the redox potential for sandstone and clay cores with an additional increase in uranium content in catalyst treated sulfuric acid solution at the “Appak” uranium deposit.

Tables 3 and 4 compare results of sandstone and clay cores treatment with sulfuric acid and a solution of “Muhamedzhan-1”. As it is shown in Table 3, treatment of sandstone core (4-4-4 B) with 25 g/l sulfuric acid yielded 147.8 g/l of uranium content in the resulting solution, whereas after treatment of core with 10 ml of “Muhamedzhan-1”, resulting solution yielded 184.1 g/l of uranium content. Treatment of clay core with 25 g/l sulfuric acid yielded 62.8 g/l of uranium content in the solution, whereas treatment with the catalyst yielded 84.9 g/l of uranium content (see Table 4).

Advantages of the inventive method follow:

1. Full (100%) substitution of hydrogen peroxide as oxidizing agent with the air.

2. Decrease of sulfuric acid consumption by 20%.

3. Decrease of leaching solution pH by 0.5-0.6 units.

4. Increase of redox potential by 100-150 mV due to air use.

TABLE 3
Results of catalytic oxidation of U(IV) to U(VI) at “Appak”
uranium deposit (sandstone core)

| Sampling | | Core: Sandstone — 4-4-4 B | | | | | | | | | | | |
|---|---|---|---|---|---|---|---|---|---|---|---|---|---|
| time, | Solution | H₂SO₄, | | Catalyst, | | Catalyst, | | H₂SO₄, | | Catalyst, | | Catalyst, | |
| hours | Parameters | 25 | g/l | 5 | ml | 10 | ml | 12 | g/l | 1 | ml | 2 | ml |

| | | | | | | | |
|---|---|---|---|---|---|---|---|
| 1 | U, mg/l | 118.6 | 124.6 | 129.3 | 118.6 | 125.6 | 139.3 |
| | pH | 0.93 | 0.96 | 0.91 | 0.93 | 0.95 | 0.92 |
| | Redox, mV | 0.500 | 0.414 | 0.400 | 0.500 | 0.534 | 0.610 |
| 4 | U, mg/l | 126.5 | 147.3 | 149.4 | 139 | 149.4 | 154.6 |
| | pH | 1.95 | 0.92 | 0.88 | 1.16 | 1.17 | 1.17 |
| | Redox, mV | 0.446 | 0.504 | 0.695 | 0.450 | 0.546 | 0.635 |
| 16 | U, mg/l | 147.8 | 164.0 | 184.1 | 156.7 | 169.4 | 178.3 |
| | pH | 0.93 | 0.89 | 0.86 | 1.14 | 1.17 | 1.15 |
| | Redox, mV | 0.437 | 0.596 | 0.649 | 0.493 | 0.546 | 0.642 |

TABLE 4
Results of catalytic oxidation of U(IV) to U(VI) at “Appak”
uranium deposit (claystone core)

| Sampling | | Core: Claystone — 1-2-3 H | | | | | | | | | | | |
|---|---|---|---|---|---|---|---|---|---|---|---|---|---|
| time, | Solution | H₂SO₄, | | Catalyst, | | Catalyst, | | H₂SO₄, | | Catalyst, | | Catalyst, | |
| hours | Parameters | 25 | g/l | 5 | ml | 10 | ml | 12 | g/l | 1 | ml | 2 | ml |

| | | | | | | | |
|---|---|---|---|---|---|---|---|
| 1 | U, mg/l | 48.3 | 53.1 | 50.5 | 48.1 | 63.1 | 65.5 |
| | pH | 0.91 | 0.92 | 0.90 | 0.91 | 0.92 | 0.90 |
| | Redox, mV | 0.479 | 0.512 | 0.600 | 0.470 | 0.513 | 0.592 |
| 4 | U, mg/l | 55.7 | 65.2 | 62.8 | 55.2 | 74.7 | 77.2 |
| | pH | 0.81 | 0.84 | 0.86 | 1.14 | 1.17 | 1.18 |
| | Redox, mV | 0.455 | 0.502 | 0.691 | 0.454 | 0.446 | 0.445 |
| 16 | U, mg/l | 62.8 | 69.4 | 84.9 | 63.3 | 78.1 | 83.3 |
| | pH | 0.94 | 0.88 | 0.87 | 1.1 | 1.15 | 1.18 |
| | Redox, mV | 0.438 | 0.593 | 0.689 | 0.442 | 0.524 | 0.626 |

Thus, the results of tests of “Muhamedzhan-1” presented above indicate that the use of the proposed catalyst of “Muhamedzhan-1” allows oxidizing U⁴⁺ to U⁶⁺ in weak acid solutions.

The low cost and availability of standard equipment for production of “Muhamedzhan-1” make this technology attractable for catalytic oxidation of U⁴⁺ to U⁶⁺.

### USED LITERATURE

L. I. Lunev, Mine systems of uranium deposits development by in-situ leaching, Moscow, 1982, pp. 8, 13,17.

We claim:

1. A catalyst called “Muhamedzhan-1” for catalytic oxidation of U⁴⁺ to U⁶⁺, wherein “Muhamedzhan-1” comprises a mixture of:
a first component consisting of d- and f-mixed valence metal salts MLₙ, wherein M is one of the following: Fe, U, Cu, and Mn, and wherein L is one of the following: NO₃⁻, SO₄²⁻Cl⁻, Br⁻, and I⁻;
a second component consisting of alkali metal halogenides MX, wherein M is one of the following: Li⁺, Na⁺, K⁺, and NH₄⁺ and wherein X is one of the following: Cl⁻, Br⁻, OH⁻, HCO₃⁻, CO₃²⁻, and I⁻ in the solid or dissolved state; wherein the weight ratio of the first and the second components in the solid state m(MLₙ)/m(MX) ranges from 1:2 to 6:1 correspondingly; and
a third component in the form of:
water (H2O) and/or primary alcohols (ROH) and/or
secondary alcohols (RRCHOH) used as a solvent, having a solution weight concentration ranging from 0.0001% to 30.0% of solid salts mixture in solution.

2. A method of catalytic oxidation of U⁴⁺ to U⁶⁺, using a catalyst added solution for extraction of uranium by in situ leaching or heap leaching, said method comprising the steps of:
A1) preparation of a concentrated solution of a catalyst called “Muhamedzhan-1” in the form of: solution of d- and f-mixed valence metal salts MLₙ, wherein M=Fe, U, Cu, Mn, and L=NO₃⁻, SO₄²⁻Cl⁻, Br⁻, I⁻ and alkali metal halogenides MX, wherein M=Li⁺, Na⁺, K⁺, NH₄⁺ and X=Cl⁻, Br⁻, OH⁻, HCO₃⁻, CO₃²⁻, I⁻ with the following composition in weight %:

| | |
|---|---|
| MLₙ: | 0.01-25.0% |
| MX: | 0.01-12.5% |
| H₂O or primary and/or secondary alcohols ROH, RRCHOH: | balance; |

B1) preparation of a leaching solution containing sulfuric acid or ammonia hydroxide with the following composition in weight %:

| | |
|---|---|
| H₂SO₄ or NH₄OH: | 0.5-10.0% |
| H₂O or primary and/or secondary alcohols ROH, RRCHOH: | balance, |

C1) adding the concentrated solution of “Muhamedzhan-1”, obtained on the step (A1), to the leaching solution, obtained on the step (B1), in the following volumetric % ratio:

| | |
|---|---|
| “Muhamedzhan-1”: | 0.1-10.0% |
| Leaching solution | balance, |

thereby obtaining a leaching solution modified with “Muhamedzhan-1”;
D1) filtration of the leaching solution modified with “Muhamedzhan-1” obtained on the step (C1) through ore, with oxidation of uranium (IV) and iron (II) ions to uranium (VI) and iron (III), and a subsequent dissolution of uranium (VI), iron (III), and other metal ions in the leaching solution filtrated through ore, thereby obtaining a filtrated leaching solution containing uranium (VI) ions;
E1) extraction of uranium from the filtrated leaching solution obtained on the step (D1), and yielding a barren solution; and
F1) regeneration of “Muhamedzhan-1” in the barren solution obtained on the step (E1) by bubbling air therethrough and addition of H₂SO₄ or NH₄OH to meet their concentration requirement of the step (B1), thereby yielding the leaching solution modified with “Muhamedzhan-1” in the oxidized form, and re-circulation of the leaching solution modified with “Muhamedzhan-1” in the oxidized form back for ore leaching at the step (D1).

3. A method of catalytic oxidation of U⁴⁺ to U⁶⁺, using a catalyst added solution for extraction of uranium by in situ leaching or heap leaching, said method comprising the steps of:
A2) preparation of a leaching solution containing sulfuric acid or ammonia hydroxide with the following components composition in weight %:
H₂SO₄ or NH₄OH: 0.5-10.0%; H2O or ROH or RRCHOH: balance;
B2) preparation of the leaching solution modified with “Muhamedzhan-1” by adding:
d- and f-mixed valence metal salts MLₙ, wherein M is one of the following: Fe, U, Cu, and Mn, and wherein L is one of the following: NO₃⁻, SO₄²⁻Cl⁻, Br⁻, and I⁻, and
alkali metal halogenides (MX, wherein M is one of the following: Li⁺, Na⁺, K⁺, and NH₄⁺, and wherein X is one of the following: Cl⁻, Br⁻, OH⁻, HCO₃⁻, CO₃²⁻, and I⁻) in their solid state;
directly to the leaching solution obtained in step (A2) thereby obtaining a leaching solution modified with “Muhamedzhan-1” with the following fractions in weight %:
MLₙ: 0.00001%-15.0%,
MX: 0.00001%-10%, and
the leaching solution obtained on the step (A2): balance;
C2) filtration of the leaching solution modified with “Muhamedzhan-1” obtained on the step (B2) through ore, with oxidation of uranium (IV) and iron (II) ions to uranium (VI) and iron (III), and a subsequent dissolution of uranium (VI), iron (III) and other metal ions in the leaching solution filtrated through ore, thereby obtaining a filtrated leaching solution containing uranium (VI) ions;
D2) extraction of uranium from the filtrated leaching solution obtained on the step (C2), and yielding a barren solution; and
E2) regeneration of “Muhamedzhan-1” in the barren solution obtained on the step (D2) by bubbling air therethrough and addition of H₂SO₄ or NH₄OH to meet the concentration requirement of the step (A2), thereby yielding the leaching solution modified with “Muhamedzhan-1” in the oxidized form, and re-circulation of the leaching solution modified with “Muhamedzhan-1” in the oxidized form back for ore leaching on the step (C2).
